(19) United States
(12) Patent Application Publication
(10) Pub. No.: US 2008/0299461 A1
(43) Pub. Date: Dec. 4, 2008

(54) Secondary battery including positive electrode or negative electrode coated with a ceramic coating portion

(76) Inventor: Jinhee Kim, Yongin-si (KR)

Correspondence Address: CHRISTIE, PARKER & HALE, LLP, PO BOX 7068, PASADENA, CA, 91109-7068, US

(21) Appl. No.: 12/152,791

(22) Filed: May 16, 2008

(30) Foreign Application Priority Data
Jun. 1, 2007 (KR) 10-2007-0053963

(51) Int. Cl. H01M 4/66

(52) U.S. Cl. 429/245

(57) ABSTRACT

A lithium secondary battery including: an electrode assembly including a positive electrode plate, a negative electrode plate, and a separator; and a case for containing the electrode assembly, wherein a ceramic coating portion is on at least one surface of the positive electrode plate or the negative electrode plate, wherein the ceramic coating portion includes a ceramic material and a binder material, and wherein the binder material includes a polymer of alkylene oxide or a copolymer thereof.

### CROSS-REFERENCE TO RELATED APPLICATION

This application claims priority to and the benefit of Korean Patent Application No. 10-2007-0053963, filed Jun. 1, 2007, in the Korean Intellectual Property Office, the entire content of which is incorporated herein by reference.

### BACKGROUND OF THE INVENTION

1. Field of the Invention

The present invention relates to a lithium secondary battery including a positive electrode plate or a negative electrode plate on at least one surface of which there is a ceramic coating portion.

2. Description of the Related Art

A secondary battery can be charged and discharged. A lithium secondary battery with a high energy density is an example of a secondary battery that can be utilized as a power source for a portable electronic device.

The lithium secondary battery includes a positive electrode plate, a negative electrode plate, and an electrolyte. Generally, a separator is also disposed between the positive electrode plate and the negative electrode plate to prevent (or to protect from) a short circuit that can be caused when the positive electrode plate directly contacts the negative electrode plate. The separator can be formed by a polymer film, such as polyethylene, polypropylene, and the like. The polymer film has an open pore structure in which pores are formed and thus the electrolyte can move between the positive electrode plate and the negative electrode plate.

However, in the case of a battery that has a separator that is formed by a separate polymer film, when the alignment of the separator is out of line due to a vibration or a falling force applied to the battery, the separator may not separate the positive electrode plate from the negative electrode plate. Accordingly, the positive electrode plate and the negative electrode plate may contact each other and thereby resulting in a short circuit therebetween, which results in disabling the battery. Also, when assembling the battery, uniform winding of the electrode plates with the polymer separator may not occur, resulting in a manufacturing instability, such as an increase in a defective unit rate due to the non-uniform winding. Also, there is a stability problem in using such a battery at high temperature. The stability problem at high temperature is caused by a short circuit between electrodes due to a melting contraction of the separator film (e.g., formed from a polyolefin material) in the high temperature environment (e.g., temperature higher than or equal to 100° C.). The above-described problems are obstacles in the development of a lithium secondary batter (e.g., a lithium ion battery).

A ceramic separator may be a solution for the stability problem in the high temperature. However, due to characteristic of ceramic, there are other problems, such as, cracks, particle detachment, and the like.

### SUMMARY OF THE INVENTION

An aspect of an embodiment of the present invention is directed toward a lithium secondary battery which includes a ceramic layer coated on at least one surface of an positive electrode plate or a negative electrode plate in order to prevent (or protect from) a short circuit between the positive electrode plate and the negative electrode plate due to a contraction or an expansion of a film separator.

An embodiment of the present invention provides a lithium secondary battery including: an electrode assembly including a positive electrode plate, a negative electrode plate, and a separator; and a case for containing the electrode assembly, wherein a ceramic coating portion is on at least one surface of the positive electrode plate or the negative electrode plate, wherein the ceramic coating portion includes a ceramic material and a binder material, and wherein the binder material includes a polymer of alkylene oxide or a copolymer thereof.

The alkylene oxide may include a material selected from the group consisting of ethylene oxide, propylene oxide, and mixtures thereof.

The polymer of alkylene oxide or the copolymer thereof may be a copolymer of ethylene oxide and propylene oxide.

The binder material may include a polymer of acrylate or methacrylate, or a copolymer thereof.

The binder material may include a polymer of butyl acrylate or a copolymer thereof.

The binder material may include a polymer of ethylhexyl acrylate or a copolymer thereof.

The ceramic material may include a material selected from the group consisting of alumina, silica, zirconia, zeolite, magnesia, titanium dioxide, and barium dioxide.

A ratio by weight of the ceramic material and the binder material of the ceramic coating portion may be 95:5.

A swelling property of the binder material with respect to an electrolyte of ethylene carbonate:ethyl methyl carbonate having a ratio by weight of 3:7 may be greater than or equal to eight times.

An oxidation potential of the binder material may be greater than or equal to 5V.

A thermal decomposition temperature of the binder material may be greater than or equal to 270° C.

The ceramic coating portion may have a thickness ranging from about 1 μm to about 100 μm.

The ceramic coating portion may have a thickness ranging from about 5 μm to about 50 μm.

The ceramic material may have a ceramic purity of greater than or equal to 99.99%.

The ceramic material may include alumina and has an alumina purity of greater than or equal to 99.99%.

### BRIEF DESCRIPTION OF THE DRAWINGS

The accompanying drawings, together with the specification, illustrate exemplary embodiments of the present invention, and, together with the description, serve to explain the principles of the present invention.

The application file contains at least one drawing executed in color. Copies of this patent application publication with color drawing(s) will be provided by the Office upon request and payment of the necessary fee.

FIG. 1a is a cross-sectional schematic view of a ceramic coating portion coated on both surfaces of a positive electrode plate according to an embodiment of the present invention;

FIG. 1b is a cross-sectional schematic view of a ceramic coating portion coated on one surface of a positive electrode plate according to another embodiment of the present invention;

FIG. 2a is a cross-sectional schematic view of a ceramic coating portion coated on both surfaces of a negative electrode plate according to an embodiment of the present invention;

FIG. 2b is a cross-sectional schematic view of a ceramic coating portion coated on one surface of a negative electrode plate according to another embodiment of the present invention;

FIG. 3 is a graph of test results on elongation rates and tensile strengths of embodiments of the present invention; and

FIG. 4 is a graph of test results on oxidation potentials of embodiments of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. In addition, when an element is referred to as being “on” another element, it can be directly on the another element or be indirectly on the another element with one or more intervening elements interposed therebetween. Like reference numerals designate like elements throughout the specification.

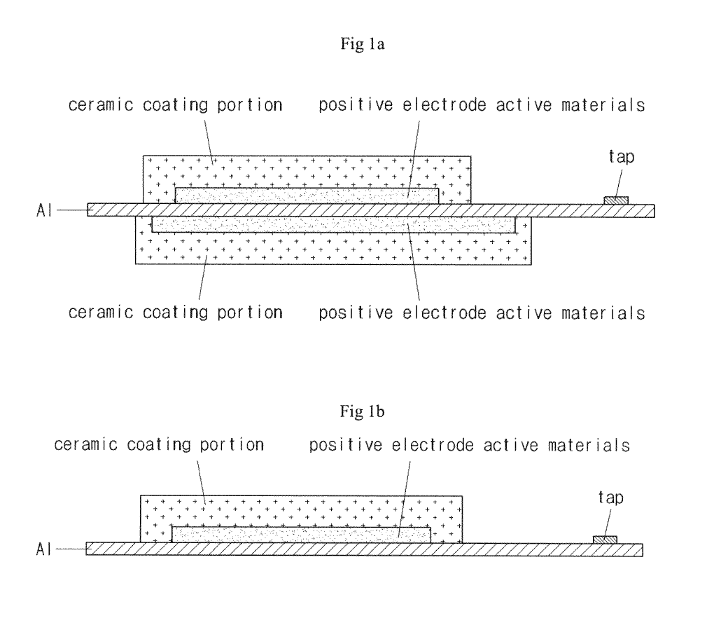

FIG. 1a is a cross-sectional schematic view of a ceramic coating portion coated on both surfaces of a positive electrode plate according to an embodiment of the present invention. In FIG. 1a, the positive electrode plate is composed of an aluminum foil (Al) and a positive electrode active material (or layer) on both surfaces of the aluminum foil. Here, the ceramic coating portion is on the positive electrode active material (or on both surfaces of the positive electrode plate). In addition, a tap is also shown to be formed one of the surfaces of the aluminum foil.

FIG. 1b is a cross-sectional schematic view of a ceramic coating portion coated on one surface of a positive electrode plate according to another embodiment of the present invention. In FIG. 1b, the positive electrode plate is composed of an aluminum foil (Al) and a positive electrode active material (or layer) on one surface of the aluminum foil. Here, the ceramic coating portion on the positive electrode active material (or on one surface of the positive electrode plate). In addition, a tap is also shown to be formed the one surface of the aluminum foil.

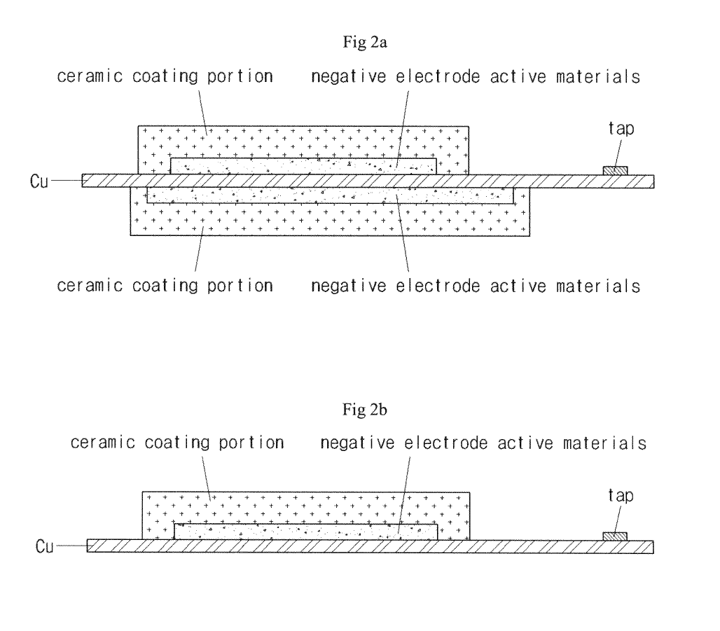

FIG. 2a is a cross-sectional schematic view of a ceramic coating portion coated on both surfaces of a negative electrode plate according to an embodiment of the present invention. In FIG. 2a, the negative electrode plate is composed of an copper foil (Cu) and a negative electrode active material (or layer) on both surfaces of the copper foil. Here, the ceramic coating portion is on the negative electrode active material (or on both surfaces of the negative electrode plate). In addition, a tap is also shown to be formed one of the surfaces of the copper foil.

FIG. 2b is a cross-sectional schematic view of a ceramic coating portion coated on one surface of a negative electrode plate according to another embodiment of the present invention. In FIG. 2b, the negative electrode plate is composed of an copper foil (Cu) and a negative electrode active material (or layer) on one surface of the copper foil. Here, the ceramic coating portion on the negative electrode active material (or on one surface of the negative electrode plate). In addition, a tap is also shown to be formed the one surface of the copper foil.

In FIGS. 1a to 2b, each of the ceramic coating portions may have a thickness ranging from about 1 μm to about 100 μm (or from 1 μm to 100 μm). In one embodiment, each of the ceramic coating portions has a thickness ranging from about 5 μm to about 50 μm (or from 5 μm to 50 μm).

### EMBODIMENT 1

A positive electrode slurry was prepared by mixing LiCoO₂ as a positive electrode active material, polyvinylidene fluoride (PVdF) as a binder, and carbon as a conductive material together at a ratio by weight of 92:4:4 in a dispersing solvent of N-methyl-2-pyrrolidinone (NMP). A positive electrode plate was prepared by coating the positive electrode slurry on an aluminum foil with a thickness of 20 μm, and then drying and rolling the positive electrode slurry coated on the aluminum foil. A ceramic paste was prepared by mixing an alumina powder material (with an alumina purity of greater than or equal to 99.99%) and a binder material, including a copolymer of ethylene oxide and propylene oxide, at a ratio by weight of 95:5 in a proper quantity of n-methyl-2-pyrrolidinone (NMP), which is the same quantity as the sum of the binder material and the alumina powder material. Next, the positive electrode plate with a ceramic coating portion was manufactured by coating the ceramic paste on the dried and rolled positive electrode plate with a thickness of 10 μm, drying the ceramic paste, coated on the positive electrode plate, at a temperature of 100° C. to thereby volatize the NMP solvent, and then hot-wind drying the ceramic paste at a temperature of 150° C. for thermal polymerization of the ceramic paste binder and for moisture removal thereof.

A negative electrode slurry was prepared by mixing graphite as a negative electrode active material, styrene-butadiene rubber as a binder, and carboxymethyl cellulose as a thickener at a ratio by weight of 96:2:2 in a dispersing solvent of water. A negative electrode plate was prepared by coating the negative electrode slurry on an aluminum foil with a thickness of 15 μm, and then drying and rolling the negative electrode slurry coated on the aluminum foil. A ceramic paste was prepared by mixing an alumina powder material and a binder material, including a copolymer of ethylene oxide and propylene oxide at a ratio by weight of 95:5 in a proper quantity of n-methyl-2-pyrrolidinone (NMP), which is the same quantity as a sum of the binder material and the alumina powder material. Next, the negative electrode plate with a ceramic coating portion was manufactured by coating the ceramic paste on the dried and rolled negative electrode plate at a temperature of 100° C. to thereby firstly volatize the NMP solvent, and then hot-wind drying the ceramic paste at a temperature of 150° C. for thermal polymerization of the ceramic paste binder and for moisture removal thereof.

A jelly roll-type electrode assembly was then formed by disposing a polyethylene separator with the thickness of 20 μm between the positive electrode plate and the negative electrode plate. A lithium secondary battery was then manufactured by adding an electrolyte, including ethylene carbonate and ethyl methyl carbonate at a ratio by weight of 3:7 with 1.3M lithium hexafluorophosphate (LiPF₆), to a cylindrical can that contains the jelly roll-type electrode assembly.

### EMBODIMENT 2

A lithium secondary battery according to Embodiment 2 was manufactured by implementing substantially the same process as Embodiment 1 except that the mixture of a copolymer of ethylene oxide and propylene oxide and a copolymer of butyl acrylate at a ratio by weight of 1:1 was used as the binder material of the alumina paste.

### EMBODIMENT 3

A lithium secondary battery according to Embodiment 3 was manufactured by implementing substantially the same process as Embodiment 1 except that the mixture of a copolymer of ethylene oxide and propylene oxide and a copolymer of ethylhexyl acrylate at a ratio by weight of 1:1 was used as the binder material of the alumina paste.

### EMBODIMENT 4

A lithium secondary battery according to Embodiment 4 was manufactured by implementing substantially the same process as Embodiment 1 except that the mixture of a copolymer of ethylene oxide and propylene oxide, a copolymer of butyl acrylate, and a copolymer of ethylhexyl acrylate at a ratio by weight of 1:1:1 was used as the binder material of the alumina paste.

In the above Embodiments 1 to 4, an active material coating portion was formed on both surfaces of the electrode plate. However, as shown in FIGS. 1a to 2b, the active material coating portion may be formed on only one surface of the positive electrode plate and the negative electrode plate or on both surfaces thereof.

Also, in the above Embodiments 1 to 4, an alumina powder (particle) material was used to form the ceramic coating portion. However, the present invention is not thereby limited, and may include ceramic pastes formed by alumina, silica, zirconia material, a zeolite, magnesia, titanium dioxide, and/or barium dioxide. That is, in one embodiment, a ceramic paste is prepared by mixing a silica powder material at 40 weight %, a binder material at 20 weight %, including a copolymer of ethylene oxide and propylene oxide, and an NMP solvent at 40 weight %; and a ceramic coating portion is formed by coating the ceramic paste (with the silica powder material) on an electrode plate. Here, as in Embodiments 1 to 4, it is expected that the ceramic coating portion should perform similar functions as the ceramic coating portions acquired in Embodiments 1 to 4.

Also, the types of the binder materials, the negative electrode active materials, and positive electrode active materials are not limited to the embodiments described above. For examples, PVdF or acryl-based rubber may be used for the binder material of the negative electrode coating portion. Also, the negative electrode active materials may include natural graphite or artificial graphite, or mixtures thereof, or metal graphite composites.

Also, a far infrared ray dry process may be used instead of the hot wind drying process as described above.

### COMPARATIVE EMBODIMENT 1

A lithium secondary battery according to Comparative Embodiment 1 was manufactured by implementing substantially the same process as Embodiment 1 except that PVdF was used as the binder material of the alumina paste.

### COMPARATIVE EMBODIMENT 2

A lithium secondary battery according to Comparative Embodiment 2 was manufactured by implementing substantially the same process as Embodiment 1 except that SBR was used as the binder material of the alumina paste.

### COMPARATIVE EMBODIMENT 3

A lithium secondary battery according to Comparative Embodiment 3 was manufactured by implementing substantially the same process as Embodiment 1 except that a copolymer of butyl acrylate was used as the binder of the ceramic paste.

### COMPARATIVE EMBODIMENT 4

A lithium secondary battery according to Comparative Embodiment 4 was manufactured by implementing substantially the same process as Embodiment 1 except that a copolymer of ethylhexyl acrylate was used as the binder of the ceramic paste.

### COMPARATIVE EMBODIMENT 5

A lithium secondary battery according to Comparative Embodiment 5 was manufactured by implementing substantially the same process as Embodiment 1 except that the mixture of a copolymer of butyl acrylate and a copolymer of ethylhexyl acrylate at the mixture ratio of 1:1 was used as the binder of the ceramic paste.

Hereinafter, an elongation rate, a tensile strength, a swelling property, a decomposition temperature, and an oxidation potential were measured by using the binder material of the ceramic paste used in each of the embodiments and the binder material used in each of the comparative embodiments. Also, an adhesive strength was measured by using a negative electrode collector in each of the embodiments and the comparative embodiments.

### TEST EXAMPLE 1

### Elongation Rate (%)

By drying all the solvent of each binder solution, gathering only the binder material that is left behind, and then hanging the binder material in a tensile strength meter and pulling the binder material in opposite directions, the maximum elongation length of the binder material, right before the binder broke (or was cut), was measured in comparison to an initial length of the binder. Then, the elongation rate of the binder material was calculated by the equation below.

Elongation rate(%)=maximum elongation length/initial length×100

### TEST EXAMPLE 2

### Tensile Strength (Mpa)

The tensile strength indicates the maximum strength of each binder material which was measured by pulling the binder material in opposite directions, right before the binder material broke (or was cut). The tensile strength of each binder material was measured by the tensile strength meter in a manner similar to the elongation rate.

Above Test Examples 1 and 2 were implemented using a test specimen having the same size of 1 cm×5 cm in the width and the length for each material.

### TEST EXAMPLE 3

### Swelling Property (Fold)

An amount of absorbable liquid weight of an electrolyte was measured by coating and drying each binder material on a Mylar film or a polyethylene film, putting the dried binder material in the electrolyte, and then measuring the increase in weight of the electrolyte before and after the binder material was put in the electrolyte. In this instance, a mixture of ethylene carbonate and ethyl methyl carbonate at a ratio by weight of 3:7 was used for the electrolyte. Then, the swelling property of the binder material was calculated by the equation below.

Swelling property=binder weight after absorbing electrolyte(g)/initial binder weight before absorbing electrolyte(g)

### TEST EXAMPLE 4

### Decomposition Temperature (° C.)

With respect to each binder sample, a starting temperature of an endothermic reaction or an exothermic reaction was measured in an N₂ gas atmosphere where a heating temperature rate was 5° C./min in a Differential Scanning Calorimetry (DSC), and a temperature range was from a normal temperature to 400° C.

### TEST EXAMPLE 5

### Oxidation Potential (V)

A working electrode was formed of grassy carbon, and a reference electrode and a counter electrode were formed of lithium metal. A voltage value was measured, and the voltage value indicates an oxidation potential value at which a current value starts increasing when increasing a voltage from an open-circuit voltage at the speed of 1 mV/sec by applying the binder material on the surface of the grassy carbon and using the mixture solvent of ethyl carbonate (EC)/ethyl methyl carbonate (EMC)(WT/WT=3:7) in which 1.3M LiPF₆ was dissolved for the electrolyte.

### TEST EXAMPLE 6

### Adhesive Strength (Peeling Strength: gf/mm)

After preparing the ceramic paste by putting the alumina material at 95 weight % and the binder material at 5 weight % into the NMP solvent, and then coating and drying the paste on a copper collector with the thickness of 10 μm, a 180° peeling strength of a ceramic coating portion with respect to the copper collector was measured. In this instance, the process of measuring the peeling strength includes switching on the power of a tensile strength meter and a personal computer (PC), executing software for driving a tester, exfoliating a protective film of a double-sided tape and then adhering adhesive surfaces of the double-sided tape to a tester plate so as to match with a tester glass plate. In this instance, a substrate was slowly stripped off from an end portion of a sample which was not adhered to the tester plate. Each of the tester glass plate adhered with the negative electrode active material and the substrate were respectively installed in the tensile strength meter using a pedal. The test was implemented by setting the tensile speed at 100 mm/min, and the elongation length at 50 mm.

Test results of above Test Examples 1 to 6 are shown in Table 1 below.

TABLE 1

| | | | | | Thermal | Electro- |
|---|---|---|---|---|---|---|
| | Mechanical property | | | | property | chemistry |
| | | | Swelling | Peeling | Decomposition | Oxidation |
| | Elongation rate | Tensile strength | property | strength | temperature | potential |
| Binder | (%) | (Mpa) | (fold) | (gf/mm) | (° C.) | (V) |
| PVdF | 100 | 1.3 | 1.1 | 5 | 130 | 5 |
| SBR | 600 | 0.6 | 1.6 | 3 | 250 | 4 |
| A | 2000 | 0.3 | 8.0 | 6 | 270 | 5 |
| B | 400 | 1.0 | 8.5 | 15 | 310 | 6 |
| C | 400 | 1.2 | 8.5 | 10 | 340 | 6 |

Binder A: copolymer of ethylene oxide and propylene oxide
Binder B: copolymer of butyl acrylate
Binder C: copolymer of ethylhexyl acrylate

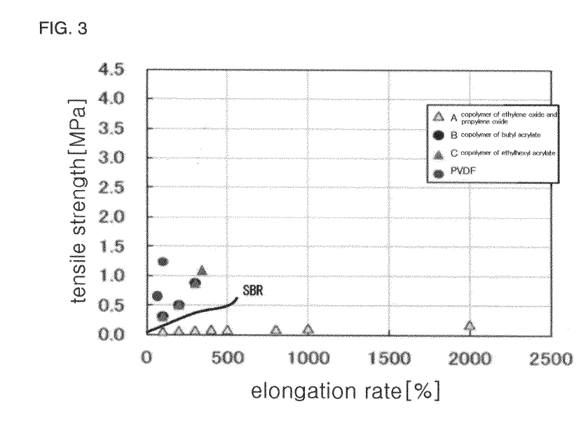

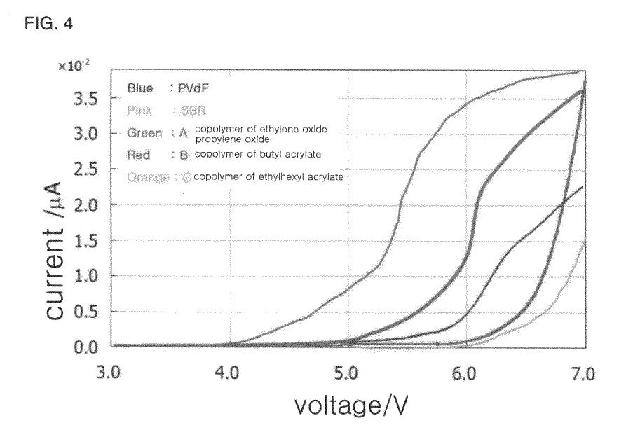

Results of Test Examples 1 to 6 are shown in Table 1 above and FIGS. 3 and 4.

As shown in Table 1 above and FIG. 3, in the case of the elongation rate and the tensile strength, PVdF had a comparatively greater tensile strength, but had the elongation rate of 100%, that is, had nearly no elongation. Conversely, SBR had a comparatively greater elongation rate, but had a comparatively lower tensile strength. However, according to the present invention, the binder A had the greatest elongation rate of 2000%, but has the lowest tensile strength. Also, the binders B and C had a comparatively good tensile strength.

Also, in the case of the swelling property, both of PVdF and SBR had a comparatively lower swelling property. As a result, when micro-cracks are formed on the ceramic coating portion due to the contraction and expansion of an active material coating portion according to charge and discharge, the degree of covering the cracks with swelling of the binder by the electrolyte is very low. Also, since PVdF and SBR had a comparatively lower adhesive strength, they may be removed (or eliminated) during a ceramic process or during a battery charge and discharge cycle. Conversely, the binders A, B, and C had the swelling property greater than PVdF and SBR by greater than or equal to eight times. Accordingly, when the micro-cracks are formed on the ceramic coating portion, the binder swells and thereby covers the cracks and also the adhesive strength increases. Accordingly, the binders A, B, and C have less probability to be removed (or eliminated) during the charge and discharge process.

Also, in the case of the peeling strength, that is, as a result of measuring the adhesive strength of the ceramic paste with respect to negative electrode active materials, the binders A, B, and C had peeling strength greater than PVdF and SBR. Therefore, according to the present invention, it can be seen that the adhesive strength thereof with respect to the positive electrode active materials or the negative electrode active materials is comparatively greater when coating the ceramic coating portion on positive electrode active materials or negative electrode active materials. Also, according to the present invention, it is possible to prevent (or protect from) a short-circuit between the positive electrode plate and the negative electrode plate by coating the ceramic coating portion on positive electrode active materials or negative electrode active materials, and thereby to sufficiently perform a function of preventing (or reducing) lifetime deterioration. Also, without disposing a film separator, the ceramic coating portion attached onto the positive electrode plate or the negative electrode plate may function as the separator.

Also, in the case of the decomposition temperature, the decomposition temperature of PVdF and SBR was 130° C. and 250° C., respectively. Also, the decomposition temperature of the binders A, B, and C was greater than or equal to 270° C. Accordingly, it can be inferred that the binders A, B, and C may maintain the coating portion without contraction or expansion even at the high temperatures, and thereby may prevent (or protect from) the short circuit between the positive electrode plate and the negative electrode plate and also may prevent (or reduce) battery deterioration.

Also, as shown in FIG. 4, in the case of the oxidation potential, SBR and PVdF initiated an oxidation at 5 V and 4 V, respectively. As a result, in a battery with a full charge potential ranging from 4.2 V to 4.4 V, the stability of the battery may deteriorate due to oxidation if the battery is overcharged or is at a high temperature. However, the binders A, B, and C initiated the oxidation at more than or equal to 5 V, and thus initiated the oxidation at potentials that relatively are higher than SBR and PVdF. Accordingly, the binders A, B, and C are determined to be more stable if the battery is overcharged or is at a high temperature.

Hereinafter, in Test Examples 7 to 11 below, a flexibility, a scratch, a nail penetration, a 150° C. oven test, and a lifetime property were tested respectively with an electrode formed by each binder material.

### TEST EXAMPLE 7

### Flexibility

The flexibility test was performed by rolling a negative electrode plate, coated with a ceramic coating portion, around a rod with a diameter of 3 mm and observing whether cracks were formed on the surface of the ceramic coating portion using an electron microscope, when the cracks were formed on the ceramic coating portion, it was indicated as ◯. Conversely, when no crack was formed on the ceramic coating portion, it was indicated as x.

### TEST EXAMPLE 8

### Scratch

The scratch test was performed by scratching the surface of the ceramic coating portion, coated on the negative electrode plate, with a wire at the pressure of 7 gf, whether the scratch was formed on the ceramic coating portion was indicated as either ◯ or x.

Test Example 8 may be implemented with the pressure range of 5 to 10 gf.

### TEST EXAMPLE 9

### 150° C. Oven Test

The oven test was performed by preparing twenty lithium secondary batteries for each embodiment, fully charging 100% the lithium secondary batteries, putting the fully charged lithium secondary batteries in an oven, and then heating the oven at the rate of 5° C./min, and maintaining the lithium secondary batteries, put in the oven, during one hour when the temperature in the oven is at 150° C., and checking whether an ignition or an explosion occurred in the oven, when there was no ignition or explosion in the oven, it was indicated as OK. Conversely, when there was ignition or explosion in the oven, it was indicated as NG.

### TEST EXAMPLE 10

### Nail Penetration

The nail penetration test was performed by preparing twenty lithium secondary batteries for each embodiment, fully charging 100% the lithium secondary batteries, and completely penetrating each of the lithium secondary batteries with a nail, and checking whether an ignition or an explosion occurred, when there was no ignition and explosion, it was indicated as OK. Conversely, when there was ignition and explosion, it was indicated as NG.

### TEST EXAMPLE 11

### Lifetime Property

The lifetime property test was performed by preparing five lithium secondary batteries for each embodiment, discharging each of the lithium secondary batteries at 1.0 C/4.2V constant-current and constant voltage (CCCV), at charge of 2.5 cutoff time, and at 1.0 C/cutoff 3.0V, and calculating the ratio of a first discharge capacity to a 300^{th} discharge capacity in %, and acquiring the mean (or average) thereof.

The results of Test Examples 7 to 11 are shown in Table 2 below.

TABLE 2

| | Ceramic coating | | | | |
|---|---|---|---|---|---|
| | portion on | | | | |
| | positive | | | | |
| | electrode | | | | |
| | plate and | | | | |
| | negative | | | | |
| | electrode plate | | Battery stability | | Battery |
| | Flex- | | 150° C. | Nail | performance |
| | ibility | Scratch | oven | penetration | Lifetime (%) |
| A | ◯ | ◯ | 20 OK | 20 OK | 94 |
| (Embodiment | | | | | |
| 1) | | | | | |
| A + B | ◯ | ◯ | 20 OK | 20 OK | 93 |
| (Embodiment | | | | | |
| 2) | | | | | |
| A + C | ◯ | ◯ | 20 OK | 20 OK | 94 |
| (Embodiment | | | | | |
| 3) | | | | | |
| A + B + C | ◯ | ◯ | 20 OK | 20 OK | 95 |
| (Embodiment | | | | | |
| 4) | | | | | |
| PVdF | X | ◯ | 20 NG | 20 NG | 70 |
| (Comparative | | | | | |
| Embodiment | | | | | |
| 1) | | | | | |
| SBR | ◯ | X | 20 NG | 20 NG | 50 |
| (Comparative | | | | | |
| Embodiment | | | | | |
| 2) | | | | | |
| B | Δ | Δ | 20 OK | 20 OK | 83 |
| (Comparative | | | | | |
| Embodiment | | | | | |
| 3) | | | | | |
| C | Δ | Δ | 20 OK | 20 OK | 85 |
| (Comparative | | | | | |
| Embodiment | | | | | |
| 4) | | | | | |
| B + C | Δ | Δ | 20 OK | 20 OK | 86 |
| (Comparative | | | | | |
| Embodiment | | | | | |
| 5) | | | | | |

Binder A: copolymer of ethylene oxide and propylene oxide
Binder B: copolymer of butyl acrylate
Binder C: copolymer of ethylhexyl acrylate

As shown in Table 2 above, the binder A had the greatest elongation rate and thus had no crack and had a comparatively greater flexibility. Also, the binder A had the comparatively greater decomposition temperature and the oxidation potential and thus the battery stability and the battery performance are improved, and the lifetime property thereof was comparatively greater (94%).

In the case of a mixture binder that includes the binders A and B, the mixture binder had no crack and scratch. Also, all of the twenty lithium secondary batteries passed the 150° C. oven test and the nail penetration test, and the lifetime property thereof was comparatively greater (93%).

In the case of a mixture binder that includes the binders A and C, the mixture binder had no crack and scratch. Also, all of the twenty lithium secondary batteries passed the 150° C. oven test and the nail penetration test, and the lifetime property thereof was comparatively greater (94%).

In the case of a mixture binder that includes the binders A, B, and C, the mixture binder had no crack and scratch. Also, all of the twenty lithium secondary batteries passed the 150° C. oven test and the nail penetration test, and the lifetime property thereof was the highest (95%).

Specifically, referring to the results of test examples, which were implemented according to the embodiments of the present invention, as shown in Table 2 above, no crack and scratch was shown in both the flexibility test and the scratch test. Also, all of the twenty lithium secondary batteries passed the 150° C. oven test and the nail penetration test, and the lifetime property thereof was greater than or equal to 90%. Accordingly, referring to the results, it can be inferred that a lithium secondary battery according to the embodiments of the present invention may maintain a coating portion without contraction or expansion even in the high temperature, and thereby may prevent (or protect from) the short-circuit between an positive electrode plate and a negative electrode plate and also may prevent a battery deterioration.

On the other hand, PVdF had the comparatively lower elongation rate, the swelling property, and the decomposition temperature, and thus the ceramic coating portion also had the lowest flexibility and the elongation rate, which resulted in creating cracks in the flexibility test. Also, in the stability test, such as the nail penetration test or the 150° C. oven test, PVdF showed the results of NG, and the lifetime property thereof was 70% due to the comparatively lower decomposition temperature and the oxidation potential.

Also, since the peeling strength of SBR was weak, scratch was formed on the ceramic coating portion made of SBR. Also, SBR showed the results of NG in the stability test, such as the nail penetration or the 150° C. oven test. Also, the lifetime property of SBR was the lowest 50%.

Also, the binders B and C had the comparatively lower elongation rate and thus cracks occurred in the flexibility test. Also, even though the lifetime property of the binders B and C was comparatively greater than PVdF or SBR, it was comparatively lower than the results of the embodiments according to the present invention.

As described above, rather than using the binders B and C, or PVdF or SBR alone, either when using only the binder A or when using the mixture binder that includes the binders A and B or the mixture binder that includes the binders A and C according to the embodiments of the present invention, comparatively excellent results were acquired.

In view of the foregoing, according to an embodiment of the present invention, a ceramic coating portion, including ceramic materials and a binder, is coated on at least one surface of an positive electrode plate or a negative electrode plate. Accordingly, it is possible to prevent (or protect from) the short-circuit between the positive electrode plate and the negative electrode plate due to a contraction and expansion of a separator.

Also, according to an embodiment of the present invention, comparatively excellent results can be acquired at a 150° C. oven test and a nail penetration test. Accordingly, a heat-resistant property is improved at a normal temperature and at a relatively high temperature and thereby the stability and the lifetime property of a battery is improved.

Also, according to an embodiment of the present invention, a ceramic coating portion is coated on at least one surface of an positive electrode plate or a negative electrode plate. Accordingly, when assembling an electrode assembly, a process of disposing a film separator may be eliminated.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A lithium secondary battery comprising:
an electrode assembly comprising a positive electrode plate, a negative electrode plate, and a separator; and
a case for containing the electrode assembly,
wherein a ceramic coating portion is on at least one surface of the positive electrode plate or the negative electrode plate,
wherein the ceramic coating portion comprises a ceramic material and a binder material, and
wherein the binder material comprises a polymer of alkylene oxide or a copolymer thereof.

2. The lithium secondary battery according to claim 1, wherein the alkylene oxide comprises a material selected from the group consisting of ethylene oxide, propylene oxide, and mixtures thereof.

3. The lithium secondary battery according to claim 2, wherein the polymer of alkylene oxide or the copolymer thereof is a copolymer of ethylene oxide and propylene oxide.

4. The lithium secondary battery according to claim 3, wherein the binder material comprises a polymer of acrylate or methacrylate, or a copolymer thereof.

5. The lithium secondary battery according to claim 3, wherein the binder material comprises a polymer of butyl acrylate or a copolymer thereof.

6. The lithium secondary battery according to claim 5, wherein the binder material comprises a polymer of ethylhexyl acrylate or a copolymer thereof.

7. The lithium secondary battery according to claim 3, wherein the binder material comprises a polymer of ethylhexyl acrylate or a copolymer thereof.

8. The lithium secondary battery according to claim 1, wherein the binder material comprises a polymer of acrylate or methacrylate, or a copolymer thereof.

9. The lithium secondary battery according to claim 1, wherein the binder material comprises a polymer of butyl acrylate or a copolymer thereof.

10. The lithium secondary battery according to claim 9, wherein the binder material comprises a polymer of ethylhexyl acrylate or a copolymer thereof.

11. The lithium secondary battery according to claim 1, wherein the binder material comprises a polymer of ethylhexyl acrylate or a copolymer thereof.

12. The lithium secondary battery according to claim 1, wherein the ceramic material comprises a material selected from the group consisting of alumina, silica, zirconia, zeolite, magnesia, titanium dioxide, and barium dioxide.

13. The lithium secondary battery according to claim 1, wherein a ratio by weight of the ceramic material and the binder material of the ceramic coating portion is 95:5.

14. The lithium secondary battery according to claim 1, wherein a swelling property of the binder material with respect to an electrolyte of ethylene carbonate:ethyl methyl carbonate having a ratio by weight of 3:7 is greater than or equal to eight times.

15. The lithium secondary battery according to claim 1, wherein an oxidation potential of the binder material is greater than or equal to 5V.

16. The lithium secondary battery according claim 1, wherein a thermal decomposition temperature of the binder material is greater than or equal to 270° C.

17. The lithium secondary battery according to claim 1, wherein the ceramic coating portion has a thickness ranging from about 1 μm to about 100 μm.

18. The lithium secondary battery according to claim 17, wherein the ceramic coating portion has a thickness ranging from about 5 μm to about 50 μm.

19. The lithium secondary battery according to claim 1, wherein the ceramic material has a ceramic purity of greater than or equal to 99.99%.

20. The lithium secondary battery according to claim 1, wherein the ceramic material comprises alumina and has an alumina purity of greater than or equal to 99.99%.
